(19) United States
(12) Patent Application Publication
(10) Pub. No.: US 2020/0255702 A1
(43) Pub. Date: Aug. 13, 2020

(54) SELF-ADHESIVE SEAL ASSEMBLY AND METHOD OF MAKING SUCH AN ASSEMBLY

(71) Applicant: SAINT-GOBAIN PERFORMANCE PLASTICS FRANCE, Charny Orée de Puisaye (FR)

(72) Inventor: Hadrien HEUCLIN, Paris (FR)

(21) Appl. No.: 16/788,929

(22) Filed: Feb. 12, 2020

(30) Foreign Application Priority Data
Feb. 13, 2019 (FR) 1901430

(51) Int. Cl. C09J 7/38; F16J 15/10; C09J 7/26

(52) U.S. Cl. CPC C09J 7/385; F16J 15/102; C09J 2433/00; C09J 2463/00; C09J 2475/00; C09J 7/26

(57) ABSTRACT

A self-adhesive seal assembly includes an elastomer seal (1), wrapped in a textile (2) and a double-sided adhesive tape (3) comprising a carrier tape (4), a first layer (5) of a pressure-sensitive adhesive (PSA) on one side of the carrier tape, a second layer (6) of a pressure-sensitive adhesive on the other side of the carrier tape, the elastomer seal (1) with the textile sheath (2) and the double-sided adhesive tape (3) irreversibly adhered to each another by means of a structural adhesive (7) forming a bonding seal. In an embodiment, also provided is a method for manufacturing such a self-adhesive seal assembly.

### CROSS-REFERENCE TO RELATED APPLICATIONS

This application claims priority under 35 U.S.C. § 119(a)-(d) to French Patent Application No. 1901430, entitled “SELF-ADHESIVE SEAL ASSEMBLY AND METHOD OF MAKING SUCH AN ASSEMBLY,” by Hadrien HEUCLIN, filed Feb. 13, 2019, which is assigned to the current assignee hereof and incorporated herein by reference in its entirety.

### FIELD OF THE DISCLOSURE

The present invention relates to a method for attaching an adhesive tape to a textile-wrapped elastomer seal, in particular a silicone profile, and to an assembly obtained by this method.

### BACKGROUND

The attachment of elastomer seals, in particular silicone ones, on the bodies of aircraft, trains or motor vehicles is conventionally done using a RTV (Room Temperature Vulcanizable) silicone adhesive. The curing of the adhesive, however, takes quite a long time, in the order of several hours to several tens of hours, and the holding in position of the joints for such a long time can be complicated to implement. This way of bonding the seals directly to the support by means of a silicone-based structural adhesive requires a large storage space and decreases the overall productivity of the method.

The idea of creating an adhesive surface on the silicone seal that is able to stick instantly to another material, for example by attaching adhesive tape with a pressure-sensitive adhesive (PSA) onto the seal, is not new, but its implementation usually faces the difficulty of creating an adhesive bond of sufficient strength between this adhesive tape and the surface of the silicone.

Another method is to wrap, or “sheathe”, elastomer seals with textiles in order to increase their mechanical strength, to protect them against mechanical stresses or to give them specific properties, for example impermeability to electromagnetic radiation. This sheathing of the joint using a textile does not substantially reduce the problem mentioned above, because the elastomer generally penetrates the textile during the manufacture of the seal and lies flush with the surface of the composite product thus obtained.

The hydrophobic surface of the elastomer can be subjected to oxidizing surface treatments (plasma, corona, UV-ozone) in order to increase, at least temporarily, the surface energy and to create —OH groups capable of reacting with an adhesive. This increase in surface energy may not remain stable over time and the material may gradually become hydrophobic again.

Accordingly, creating an adhesive bond of sufficient strength is desired.

### SUMMARY

In an embodiment, a self-adhesive seal assembly is provided. The self-adhesive seal assembly includes an elastomer seal, wrapped in a textile and a double-sided adhesive tape including: (i) a carrier tape; (ii) a first layer of a pressure-sensitive adhesive (PSA) on one side of the carrier tape; and (iii) a second layer of a pressure-sensitive adhesive on the other side of the carrier tape, the elastomer seal with the textile sheath and the double-sided adhesive tape irreversibly adhered to each another by means of a structural adhesive forming a bonding seal.

In another embodiment, a method of manufacturing a self-adhesive seal assembly is provided. The method of manufacturing a self-adhesive seal assembly includes the following steps:

(a) the provision of an elastomer seal wrapped in a textile,
(b) the provision of a double-sided adhesive tape including:
a carrier tape,
a first layer of a pressure-sensitive adhesive (PSA) on one side of the carrier tape,
a second layer of a PSA on the other side of the carrier tape,
   (c) the application of a structural adhesive to an area of the surface of the elastomer seal wrapped in the textile and/or on the first layer of PSA,
   (d) bringing said area into contact with the surface of the elastomer seal wrapped in the textile with the first layer of PSA, and
   (e) curing the structural adhesive.

### BRIEF DESCRIPTION OF THE DRAWING(S)

The present disclosure may be better understood, and its numerous features and advantages made apparent to those skilled in the art by referencing the accompanying drawings.

FIG. 1 includes an illustration of an exemplary seal assembly.

### DETAILED DESCRIPTION

The following description in combination with the FIGURE is provided to assist in understanding the teachings disclosed herein. The following discussion focuses on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are open-ended terms and should be interpreted to mean “including, but not limited to . . . . ” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at room temperature, such as about 77° F. (25° C.). For instance, values for viscosity are at 77° F. (25° C.), unless indicated otherwise.

The Applicant has carried out a number of tests aimed at obtaining a strong adhesive bond between a PSA adhesive tape and a composite surface formed by a textile and a hydrophobic elastomer and previously activated (that is to say made more hydrophilic) by a surface treatment. The Applicant has tested silicone and non-silicone structural adhesives, as well as various pressure-sensitive adhesives (PSAs) allowing instant adhesion between the two surfaces.

Surprisingly, the highest adhesion (peel strength) values are obtained by combining a structural adhesive with a pressure-sensitive adhesive (PSA). In other words, the presence of a pressure-sensitive adhesive (PSA) on the side of the adhesive tape intended to be brought into contact with the hydrophobic elastomer profile increases the peel strength of a bonding made using a structural adhesive.

The pressure-sensitive adhesive (PSA), present as a thin layer on the surface of the carrier tape, does not weaken the adhesive bond, as might have been feared, but dramatically strengthens it, the peel strength being approximately two to ten times higher than in the absence of a PSA.

This invention has discovered that a pressure-sensitive adhesive (PSA), normally intended for direct gluing onto the substrate to be bonded, due to its high tack, can function as a sort of bonding layer for a structural adhesive.

In an embodiment, a self-adhesive seal assembly is provided that includes an elastomer seal wrapped in a textile and a double-sided adhesive tape including: (i) a carrier tape, (ii) a first layer of a pressure-sensitive adhesive (PSA) on one side of the carrier tape, and (iii) a second layer of a pressure-sensitive adhesive on the other side of the carrier tape, the textile-wrapped elastomer seal and the double-sided adhesive tape are irreversibly bonded to each other using a structural adhesive forming a bonding seal.

In another embodiment, a method for manufacturing such a self-adhesive seal assembly is provided. This method includes the following steps:

(a) the provision of a textile-wrapped elastomer seal,
(b) the provision of a double-sided adhesive tape including
a carrier tape,
a first layer of a pressure-sensitive adhesive (PSA) on one side of the carrier tape,
a second layer of a PSA on the other side of the carrier tape,
   (c) applying a structural adhesive to an area of the surface of the textile-wrapped elastomer seal and/or to the first PSA layer,
   (d) bringing said area of the surface of the textile-wrapped elastomer seal into contact with the first PSA layer, and
   (e) curing the structural adhesive.

Structural adhesives are adhesives used to bond together two materials irreversibly. They can cure by evaporation of a solvent, by cooling (hot-melt adhesives) or by chemical reaction and formation of a three-dimensional polymer network (crosslinking). In a particular embodiment, the structural adhesive used in this invention is selected from among those which cure by chemical reaction. Their glass transition temperature (Tg) is generally, but not necessarily, significantly greater than the intended use temperature. Typically, therefore, the structural adhesive is in a vitreous, rigid state. There are certain structural adhesives, particularly polyurethanes, intended for use at a temperature above their Tg, but these adhesives are less potent than those with a high Tg, and are therefore not typically preferred. Whether they are being used at temperatures greater or less than the intended use temperature, it is generally appropriate to choose a structural adhesive with a Tg quite far from this temperature of use, otherwise its adhesion performance will vary greatly in the event of thermal variations.

The main chemical classes of structural adhesives are epoxy, acrylic, cyanoacrylic and phenolic adhesives as well as polyurethane and silicone adhesives. In an embodiment, the structural adhesives used in this invention are non-silicone adhesives, i.e. they contain less than 30% polyorganosiloxanes by weight, and in a particular embodiment, less than 10% polyorganosiloxanes by weight, such as less than 5% polyorganosiloxanes by weight and in an embodiment, less than 1% polyorganosiloxanes by weight.

The term “structural adhesive” encompasses both single-component and two-component adhesive compositions.

In an embodiment, the structural adhesive includes chemical functions capable of reacting with labile hydrogen groups, and in a particular embodiment hydroxyl groups, such as isocyanate functions (present in polyurethanes) and epoxide functions (present in epoxy adhesives). The presence of such functions ensures good adhesion of the structural adhesive to the surface of the silicone part which, after surface treatment, has a multitude of SiOH functions.

For the reasons set out above, and in a particular embodiment, the structural adhesive is selected from an epoxy adhesive and a polyurethane.

Polyurethane-type structural adhesive compositions generally contain isocyanate-functional pre-polymers and a curer, typically a polyol or other compound having at least two functions with labile hydrogen. The curer can also be the moisture in the atmosphere. Structural adhesives of the polyurethane type are described, inter alia, in the following patents: U.S. Pat. Nos. 4,511,626, 4,515,933, 4,551,517, 5,290,853, 5,719,252, 723,534, 5,852,103, 5,900,809 and 6,130,268.

Examples are 3M™ Scotch-Weld™ Urethane Adhesive and Bostik PU construction sealants.

An epoxy structural adhesive generally contains glycidyl functional monomers or pre-polymers and an amine curer. Epoxy structural adhesives are described, for example, in the following applications and patents: U.S. Pat. Nos. 7,157,143, 8,618,204, US 2004/0072927 and US 2008/0045670. Epoxy structural adhesives also may be in the form of single-component or two-component kits containing two reactive compositions which are mixed immediately before use.

Pressure-sensitive adhesives (PSAs) are adhesives generally present as a thin layer on a base. They stick almost immediately, by simple contact and application of pressure, to the material to be bonded. Although there are some PSAs with very high adhesive power, the vast majority of PSAs are considered non-structural or semi-structural adhesives, i.e. their bonding is reversible. The glass transition temperature of PSAs is always significantly lower than the intended use temperature. At ambient temperature, the polymer network forming the adhesive layer is therefore a viscoelastic fluid, the high mobility of the polymer chains being a prerequisite for the formation of a multitude of weak bonds (van der Waal and hydrogen bonds) between the adhesive and the surface to be bonded.

PSAs are generally characterized by their tack, peel strength and shear strength.

There are typically three main chemical classes of pressure-sensitive adhesives: a PSA based on an elastomer; an acrylic PSA; and a silicone-based PSA.

In a particular embodiment, the PSAs used in this invention are not a silicone-based PSA. Those used on the first side of the double-sided adhesive tape are typically an acrylic PSA. The PSA applied on the second side of the ribbon can be chosen freely according to the material to which it must adhere.

A double-sided adhesive tape having at least one layer of acrylic PSA is known and described in numerous patent applications, examples of which include the following: US2011/0244230, US2011/012966, US2013/0078463, U.S. Pat. No. 8,828,539, US2001/0033988, EP 0 587 752, EP 2 385 090, EP 2 499 194, EP 2 551320, US 2011/0043737.

Such a double-sided adhesive tape including at least one acrylic PSA layer is commercially available and sold, for example by Saint-Gobain Performance Plastics under the name Normount® A6100 to A6300, and by Scapa under the names AS1270, AS1160, AS197K, C705.

The first PSA layer, intended to be bonded by means of a structural adhesive on the surface of the silicone part, has an area density of between 10 and 50 g/m², such as between 15 and 40 g/m².

The carrier tape may be of any material suitable for the intended use. It can be a tape based on cellulosic fiber, such as paper, or assembled polymer fiber in the form of non-woven fibers. In an embodiment, the form of the carrier tape is a film made from thermoplastic organic polymer. In a particular embodiment, the carrier tape can be an expanded film, i.e. a foam.

The polymer forming the carrier tape of the double-sided adhesive tape is typically selected from the group consisting of a polyester, a polyvinyl chloride, a fluoropolymer, a polyimide, an ethylene-propylene-diene monomer, a polyurethane, an acrylate, and a polyolefin such as polyethylene.

In a particular embodiment, the double-sided adhesive tape includes a homogeneous mass of foamed acrylic adhesive. In such an adhesive tape, the three layers described above (first layer of PSA, carrier tape, second layer of PSA) cannot be distinguished from one another because they are formed of one and the same material, namely: a viscoelastic acrylic material appearing to have the properties of a PSA. Such tapes are marketed by 3M under the name VHB®.

Textile-wrapped elastomer seals are well-known and their manufacture is described in U.S. Pat. No. 3,531,829 and GB1264881, for example. They are marketed by Seal Science Inc., for example.

In a particular embodiment, the elastomer seal is made of silicone.

The textile which sheaths the elastomer seal is typically chosen from a textile made of polyester fiber, glass fiber, quartz fiber, aramid fiber, carbon fiber, ceramic fiber, or metal fiber, in particular aluminum fiber. In a particular embodiment, the fiber is at least partially integrated into the mass of the elastomer, and in a more particular embodiment, a silicone.

In an embodiment, the textile-wrapped elastomer seal is in the form of a profile, hollow, or solid. It is an advantage for this profile to have a flat surface onto which the double-sided adhesive tape will be placed. In a particular embodiment, the length of the double-sided adhesive tape is virtually equal to the length of the profile. Furthermore, after application/bonding, the double-sided adhesive tape particularly covers the entire flat surface of the profile.

In an embodiment, in order for the non-silicone structural adhesive used to adhere optimally to the elastomer seal, it is worth preparing the surface of the latter using a surface treatment leading to an increase in surface energy. Silicone (polyorganosiloxane) generally has, before treatment, a surface energy of the order of 20 mJ/m². Such a surface is, however, not typically moistened satisfactorily by a non-silicone adhesive composition.

Therefore and in a particular embodiment, the area of the surface of the elastomer seal which is intended to receive the structural adhesive is subjected to a surface treatment making it possible to increase the surface energy to a value at least equal to 30 mJ/m². All surface energy values are understood to have been determined by the sessile drop method using the Owens-Wendt theory (D. Owens, R. Wendt, Estimate of the Surface Free Energy of Polymers. in J. Appl. Polym. Sci., 13 (1969), P. 1741-1747).

In a particular embodiment, the surface treatment is a treatment using flame, plasma containing oxygen (O₂), plasma torch, corona discharge, infrared irradiation, UV-ozone or chemical treatment, for example with a strong acid, strong base or oxidant.

In a particular embodiment, this hydrophilizing treatment is implemented shortly before the treated surface comes into contact with the structural adhesive, and in a particular embodiment, a non-silicone. It is known that the hydrophilic nature of the treated area is only transient and disappears fairly quickly. This phenomenon, known as “hydrophobic recovery”, can occur in just a few minutes and is generally attributed to the condensation of silanol groups, the reorientation of polar groups, and the migration of low molecular weight components from within the part towards the surface.

In the method used and in a particular embodiment, the surface treatment is typically carried out less than 5 minutes, such as less than 3 minutes, and even less than one minute before bringing the treated area into contact with the structural adhesive.

The structural adhesive may be applied to the area of the elastomer seal surface or the PSA layer of the double-sided tape, or both. It is typically applied to the elastomer seal, typically made of silicone.

In a particular embodiment, the structural adhesive is applied in an amount of between 8 and 1500 g/m², such as between 40 and 450 g/m².

The curing of the structural adhesive can be done without energy input, for example when the curing reaction occurs between the two reagents of a two-component adhesive, which are stored as two separate compositions and are only mixed together immediately before application, or in the case of a single-component adhesive which uses the water in the atmosphere for the curing reaction.

In a particular embodiment, the curing reaction is triggered or accelerated by the supply of thermal or actinic energy. A photocuring adhesive composition can thus be used when the adhesive tape and/or the elastomer seal are not opaque to light.

The thickness of the cured structural adhesive layer is typically between 10 μm and 1 mm, such as between 50 μm and 300 μm.

In a more advantageous form of an embodiment of this invention, pressure is applied to the bonding seal during at least a portion of the curing phase.

In a particular embodiment, the bonding method described above is a continuous process, wherein each of the steps described above (surface treatment—application of a structural adhesive—bringing into contact—curing) corresponds to a work station in a dedicated installation. In such a dedicated installation, the elastomer seal, and in a particular embodiment, a silicone profile, passes successively: through a surface treatment station; optionally through a structural adhesive application station; through a station for coming into contact with the double-sided adhesive tape, then through a heating or irradiation station.

The bonding seal between the elastomer seal and the double-sided adhesive tape has a peel strength (measured according to ISO 4578) of greater than 8 N/cm, such as of between 10 and 100 N/cm, and in a particular embodiment between 12 and 80 N/cm.

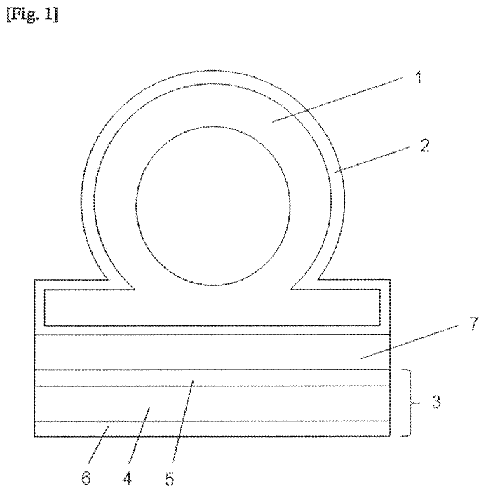

An exemplary illustration can be seen with reference to FIG. 1 [FIG. 1] which shows a cross-section of a self-adhesive seal assembly in accordance with an embodiment of the invention.

In this FIG. 1 the elastomer seal 1 is a cylindrical tube combined with a straight portion having a flat outer surface. In cross-section, this elastomer seal thus presents the shape of the letter “omega” with a closed base. The elastomer seal 1 is surrounded on its entire surface with a textile 2 which perfectly fits the outer surface of the seal. The elastomer seal 1 wrapped in a textile 2 is glued onto a double-sided adhesive tape 3 with at least one bonding seal formed of a structural adhesive 7. The double-sided adhesive tape 3 includes a carrier tape 4 with, on one of its two surfaces, a first layer 5 of a pressure-sensitive adhesive, and on its other surface, a second layer 6 of a pressure-sensitive adhesive.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

### Embodiment 1

A self-adhesive seal assembly, including an elastomer seal (1), wrapped in a textile (2) and a double-sided adhesive tape (3) including (i) a carrier tape (4), (ii) a first layer (5) of a pressure-sensitive adhesive (PSA) on one side of the carrier tape, (iii) a second layer (6) of a pressure-sensitive adhesive on the other side of the carrier tape, the elastomer seal (1) with the textile sheath (2) and the double-sided adhesive tape (3) irreversibly adhered to each another by means of a structural adhesive (7) forming a bonding seal.

### Embodiment 2

The assembly in accordance with embodiment 1, wherein the structural adhesive is a non-silicone structural adhesive.

### Embodiment 3

The assembly in accordance with embodiment 2, wherein the non-silicone structural adhesive is selected from an epoxy adhesive and a polyurethane.

### Embodiment 4

The assembly in accordance with any one of the preceding embodiments, wherein the structural adhesive bonding joint between the elastomer seal (1) with textile sheath (2) and the double-sided adhesive tape (3) has a peel strength greater than 8 N/cm, such as between 10 and 100 N/cm.

### Embodiment 5

The assembly in accordance with any one of the preceding embodiments, wherein the adhesive forming the first layer (5) of PSA is an acrylic adhesive.

### Embodiment 6

The assembly according to any one of the preceding embodiments, wherein the structural adhesive includes functions capable of reacting with labile hydrogen groups, such as with hydroxyl groups.

### Embodiment 7

The assembly in accordance with any one of the preceding embodiments, wherein the carrier tape is a foam.

### Embodiment 8

The assembly in accordance with any one of the preceding embodiments, wherein the textile-wrapped elastomer seal is a profile having a planar surface.

### Embodiment 9

The assembly in accordance with any one of the preceding embodiments, wherein the elastomer seal is a silicone seal.

### Embodiment 10

The assembly in accordance with any one of the preceding embodiments, wherein the textile wrapped around the elastomer seal is a textile made of polyester fiber, glass fiber, quartz fiber, aramid fiber, carbon fiber, ceramic fiber, or metal fiber.

### Embodiment 11

A method of manufacturing a self-adhesive seal assembly in accordance with any one of the preceding embodiments, including the following steps:

(a) providing an elastomer seal (1) wrapped in a textile (2),
(b) providing a double-sided adhesive tape (3) including: a carrier tape (4), a first layer (5) of a pressure-sensitive adhesive (PSA) on one side of the carrier tape, and a second layer (6) of a PSA on the other side of the carrier tape,
(c) application of a structural adhesive (7) to an area of the surface of the elastomer seal (1) wrapped in the textile (2) and/or on the first layer of PSA,
(d) bringing said area into contact with the surface of the elastomer seal (1) wrapped in the textile (2) with the first layer of PSA, and (e) curing the structural adhesive.

### Embodiment 12

The method in accordance with embodiment 11, wherein the area of the surface of the elastomer seal that is to receive the structural adhesive is subjected to a surface treatment to increase the surface energy to a value of at least equal to 30 mJ/m².

### Embodiment 13

The method in accordance with embodiment 11, wherein the structural adhesive is a non-silicone structural adhesive.

### Embodiment 14

The method in accordance with embodiment 13, wherein the non-silicone structural adhesive is selected from an epoxy adhesive and a polyurethane.

### Embodiment 15

The method in accordance with any one of embodiments 11 to 14, wherein the adhesive forming the first layer (5) of PSA is an acrylic adhesive.

### Embodiment 16

The method in accordance with any one of embodiments 11 to 15, wherein the structural adhesive includes functions capable of reacting with labile hydrogen groups, such as with hydroxyl groups.

### Embodiment 17

The method in accordance with any one of embodiments 11 to 16, wherein the carrier tape is a foam.

### Embodiment 18

The method in accordance with any one of embodiments 11 to 17, wherein the textile-wrapped elastomer seal is a profile having a planar surface.

### Embodiment 19

The method in accordance with any one of embodiments 11 to 18, characterized by the fact that it is a continuous method.

### Embodiment 20

The method in accordance with any one of embodiments 11 to 19, wherein the elastomer seal is a silicone seal.

### Embodiment 21

The method in accordance with any one of embodiments 11 to 20, wherein the textile wrapped around the elastomer seal is a textile made of polyester fiber, glass fiber, quartz fiber, aramid fiber, carbon fiber, ceramic fiber, or metal fiber.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A self-adhesive seal assembly comprises: an elastomer seal wrapped in a textile and a double-sided adhesive tape comprising:
(i) a carrier tape,
(ii) a first layer of a pressure-sensitive adhesive (PSA) on one side of the carrier tape, and
(iii) a second layer of a pressure-sensitive adhesive on the other side of the carrier tape,
wherein the elastomer seal with the textile sheath and the double-sided adhesive tape are irreversibly adhered to each another by means of a structural adhesive forming a bonding seal.

2. The assembly in accordance with claim 1, wherein the structural adhesive is a non-silicone structural adhesive.

3. The assembly in accordance with claim 2, wherein the non-silicone structural adhesive is selected from an epoxy adhesive and a polyurethane.

4. The assembly in accordance with claim 1, wherein the structural adhesive bonding joint between the elastomer seal with the textile sheath and the double-sided adhesive tape has a peel strength greater than 8 N/cm, such as between 10 and 100 N/cm.

5. The assembly in accordance with claim 1, wherein the adhesive forming the first layer of PSA comprises an acrylic adhesive.

6. The assembly in accordance with claim 1, wherein the structural adhesive comprises functions capable of reacting with labile hydrogen groups, such as with hydroxyl groups.

7. The assembly in accordance with claim 1, wherein the carrier tape comprises a foam.

8. The assembly in accordance with claim 1, wherein the textile-wrapped elastomer seal comprises a profile having a planar surface.

9. The assembly in accordance with claim 1, wherein the elastomer seal comprises a silicone seal.

10. The assembly in accordance with claim 1, wherein the textile wrapped around the elastomer seal comprises a textile made of polyester fiber, glass fiber, quartz fiber, aramid fiber, carbon fiber, ceramic fiber, or metal fiber.

11. A method of manufacturing a self-adhesive seal assembly comprising the following steps:
(a) providing an elastomer seal wrapped in a textile,
(b) providing a double-sided adhesive tape comprising
(i) a carrier tape,
(ii) a first layer of a pressure-sensitive adhesive (PSA) on one side of the carrier tape,
(iii) a second layer (6) of a PSA on the other side of the carrier tape,
(c) applying a structural adhesive to an area of the surface of the elastomer seal wrapped in the textile and/or on the first layer of PSA,
(d) bringing said area into contact with the surface of the elastomer seal wrapped in the textile with the first layer of PSA, and
(e) curing the structural adhesive.

12. The method in accordance with claim 11, wherein the area of the surface of the elastomer seal that is to receive the structural adhesive is subjected to a surface treatment to increase the surface energy to a value of at least equal to 30 mJ/m².

13. The method in accordance with claim 11, wherein the structural adhesive is a non-silicone structural adhesive.

14. The method in accordance with claim 13, wherein the non-silicone structural adhesive is selected from an epoxy adhesive and a polyurethane.

15. The method in accordance with claim 11, wherein the adhesive forming the first layer of PSA comprises an acrylic adhesive.

16. The method in accordance with claim 11, wherein the structural adhesive comprises functions capable of reacting with labile hydrogen groups, such as with hydroxyl groups.

17. The method in accordance with claim 11, wherein the carrier tape comprises a foam.

18. The method in accordance with claim 11, wherein the textile-wrapped elastomer seal comprises a profile having a planar surface.

19. The method in accordance with claim 11, characterized by the fact that it is a continuous method.

20. The method in accordance with claim 11, wherein the elastomer seal comprises a silicone seal.
